(19) United States
(12) Patent Application Publication
(10) Pub. No.: US 2025/0139319 A1
(43) Pub. Date: May 1, 2025

(54) TECHNIQUES FOR ENABLING VEHICLE TIME-BASED MODELING VIA A CUSTOM IMPORT LIBRARY IN VEHICLE EVENT-BASED MODELING

(71) Applicant: FCA US LLC, Auburn Hills, MI (US)

(72) Inventors: Theodore Elle Mbeng, Berkley, MI (US); Divya Gorecki, Troy, MI (US)

(21) Appl. No.: 18/498,260

(22) Filed: Oct. 31, 2023

(51) Int. Cl. G06F 30/15; G06F 111/20

(52) U.S. Cl. CPC G06F 30/15; G06F 2111/20

(57) ABSTRACT

Simulation techniques for development and verification of a system of a vehicle include a computer system configured to access a memory configured to store a custom import library defining a plurality of time-based models for various vehicle systems, to receive, from a user, first input defining an event-based model of the vehicle system, during the defining of the event-based model, output, to the user, the custom import library and receive, from the user, second input selecting one of the plurality of time-based models, execute a simulation of the event-based model, including simulating the selected time-based model, and upon executing the event-based model, display, to the user, results of the simulation of the event-based model, including a graphical display of the time-based model simulation.

### FIELD

The present application generally relates to vehicle development and verification and, more particularly, to techniques for enabling vehicle time-based modeling via a custom import library in vehicle event-based modeling.

### BACKGROUND

Model-based systems engineering (MBSE) involves the use of a software tool, such as IBM Rhapsody®. These software tools allow systems engineers to graphically design/layout a system and perform event-based modeling. In vehicle development and verification, these event-based models are often based on one or more continuous (time-based) models, which are designed and optimized by controls engineers using another software tool, such as MathWorks Simulink®. Currently, there is no single software tool capable of performing all of these functionalities. This often results in systems and controls engineers going back-and-forth to each other with adjustments throughout the vehicle development and verification process, which is both time consuming and expensive. Accordingly, while such conventional vehicle development and verification techniques do work well for their intended purpose, there exists an opportunity for improvement in the relevant art.

### SUMMARY

According to one example aspect of the invention, a simulation system for development and verification of a system of a vehicle is presented. In one exemplary implementation, the simulation system comprises a memory configured to store a custom import library defining a plurality of time-based models for various vehicle systems and a computer system configured to access the memory and to receive, from a user, first input defining an event-based model of the vehicle system, during the defining of the event-based model, output, to the user, the custom import library and receive, from the user, second input selecting one of the plurality of time-based models, execute a simulation of the event-based model, including simulating the selected time-based model, and upon executing the event-based model, display, to the user, results of the simulation of the event-based model, including a graphical display of the time-based model simulation.

In some implementations, the event-based model of the vehicle system is a graphical system model. In some implementations, the event-based modeling software is IBM Rhapsody® and the time-based modeling software is MathWorks Simulink®. In some implementations, the graphical display of the time-based model simulation is a pop-up window within a primary window for defining the event-based model, the computer system is further configured to execute a third software that provides the custom import library and the pop-up window via the event-based modeling software.

In some implementations, the vehicle system is a battery system of the vehicle that is defined by both event-based parameters and time-based parameters. In some implementations, the event-based parameters of the battery system include a state of charge (SOC) percentage of the battery system and the time-based parameters of the battery system include at least one of a current, a voltage, and a temperature of the battery system. In some implementations, the user is a systems engineer that is not required to interact with a controls engineer. In some implementations, the custom import library includes at least one of predefined time-based models for the various vehicle systems and user-defined time-based models for the various vehicle systems.

According to another example aspect of the invention, a simulation method for development and verification of a system of a vehicle is presented. In one exemplary implementation, the simulation method comprises storing, by a memory, a custom import library defining a plurality of time-based models for various vehicle systems, accessing, by a computer system, the memory, receiving, by the computer system and from a user, first input defining an event-based model of the vehicle system, during the defining of the event-based model, outputting, by the computer system and to the user, the custom import library and receiving, by the computer system and from the user, second input selecting one of the plurality of time-based models, executing, by the computer system, a simulation of the event-based model, including simulating the selected time-based model, and upon executing the event-based model, displaying, by the computer system and to the user, results of the simulation of the event-based model, including a graphical display of the time-based model simulation.

In some implementations, the event-based model of the vehicle system is a graphical system model. In some implementations, the event-based modeling software is IBM Rhapsody® and the time-based modeling software is MathWorks Simulink®. In some implementations, the graphical display of the time-based model simulation is a pop-up window within a primary window for defining the event-based model, the computer system is further configured to execute a third software that provides the custom import library and the pop-up window via the event-based modeling software.

In some implementations, the vehicle system is a battery system of the vehicle that is defined by both event-based parameters and time-based parameters. In some implementations, the event-based parameters of the battery system include a state of charge (SOC) percentage of the battery system and the time-based parameters of the battery system include at least one of a current, a voltage, and a temperature of the battery system. In some implementations, the user is a systems engineer that is not required to interact with a controls engineer. In some implementations, the custom import library includes at least one of predefined time-based models for the various vehicle systems and user-defined time-based models for the various vehicle systems.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an example simulation system for time-based modeling via a custom import library in event-based modeling of a vehicle system according to the principles of the present application;

FIG. 2 is a view of an example user interface of event-based simulation software enabled with time-based modeling via a custom import library according to the principles of the present application; and

FIG. 3 is a flow diagram of an example method for enabling time-based modeling via a custom import library in event-based modeling for a vehicle system according to the principles of the present application.

### DESCRIPTION

As previously discussed, there is currently not a single fully-integrated software tool capable of performing both event-based modeling and time-based modeling. Thus, the development/verification process for a vehicle system can include many back-and-forth iterations between systems engineers and controls engineers, which is costly and time consuming. Accordingly. techniques that incorporate time-based simulation elements from a time-based modeling software tool (e.g., MathWorks Simulink®) in an event-based model while the event-based model is being developed in an event-based modeling software tool (e.g., IBM Rhapsody®) are presented herein.

These techniques involve creating a custom import library of time-based simulation elements or models for various vehicle systems that are accessible during the event-based modeling. Once a time-based simulation element or model is added to an event-based model, the user (i.e., the systems engineer) is then able to adjust its parameters via the event-based modeling tool or software without the need for assistance by a controls engineer. One primary example of the need for this co-simulation is battery modeling, which involves both time-based simulation (current, voltage, temperature, etc.) and event-based modeling (SOC % estimation). The potential benefits include decreased development/verification times and costs.

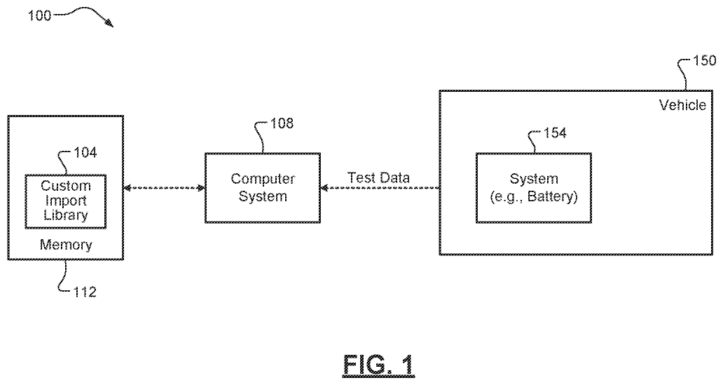

Referring now to FIG. 1, a functional block diagram of an example simulation system 100 for time-based modeling via a custom import library 104 in event-based modeling of a system 154 of a vehicle 150 according to the principles of the present application is illustrated. The simulation system 100 generally comprises a computer system 108 configured to execute time-based modeling and event-based modeling software tools. The computer system 108 includes one or more computing devices each having one or more processors and a user interface (mouse/keyboard, display, etc.). In one exemplary implementation, the computer system 108 is configured to execute the event-based modeling software tool in a foreground and execute the time-based simulation software in a background.

It will be appreciated, however, that the computer system 108 could only execute the event-based modeling software tool and could then access the time-based modeling software tool as needed (e.g., in response to function calls). In one exemplary implementation, the computer system 108 could execute a third software that provides the custom import library and the pop-up window via the event-based modeling software. The computer system 108 may also be configured to access previously obtained test data for the vehicle system 154 to be used in performing the modeling/simulations.

During the operation of the event-based modeling software tool, a user (e.g., a systems engineer) creates an event-based simulation, which typically comprises a block-based graphical representation of a system (e.g., the system 154). In one exemplary implementation, the system 154 is a battery system (such as a high voltage battery system or battery pack) of an electrified configuration of the vehicle 150. It will be appreciated, however, that the techniques of the present application are not limited to battery system simulations and are equally applicable to a variety of other simulations of vehicle systems. In some cases, the user commands the computer system 108 to access the custom import library 104, which could be stored in a local or remote memory 112. This access of the custom import library allows the user to incorporate a time-based model into the event-based model currently being designed. In other words, the user is able to incorporate time-based simulation elements from a time-based modeling software tool (e.g., Simulink®) in an event-based model while the event-based model is being developed in an event-based modeling software tool (e.g., Rhapsody®). Execution of the simulation will thereafter generate results for both the event-based simulation as well as additional results for the time-based simulation(s).

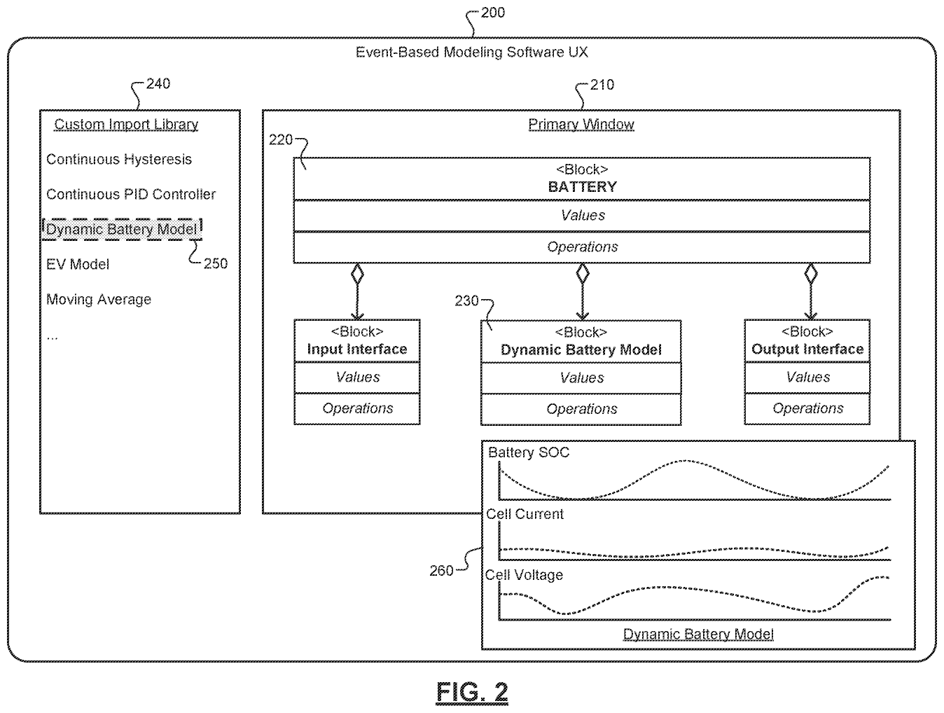

Referring now to FIG. 2 and with continued reference to FIG. 1, a view of an example user interface (UX) 200 of event-based simulation software enabled with time-based modeling via a custom import library according to the principles of the present application is illustrated. The UX 200 includes a primary window 210 where the user designs the event-based model. As shown, the event-based model includes a battery block 220, which further interacts with input/output interface blocks and a dynamic battery system block 230. This dynamic battery system block 230 is a time-based model, which is imported into the event-based model via the custom import library 104, which is also displayed in a separate window 240 with a corresponding user selection 250. By selecting and importing this time-based model into the event-based model, the user is able to perform a co-simulation. Simulation results for the execution of the event-based model are displayed as conventionally/normally performed, but the simulation results for the execution of the time-based dynamic battery model are separately displayed to the user, such as via the pop-up window 260. As shown, these results include various time-varying parameters such as cell voltage/current and then the overall estimated battery SOC (%).

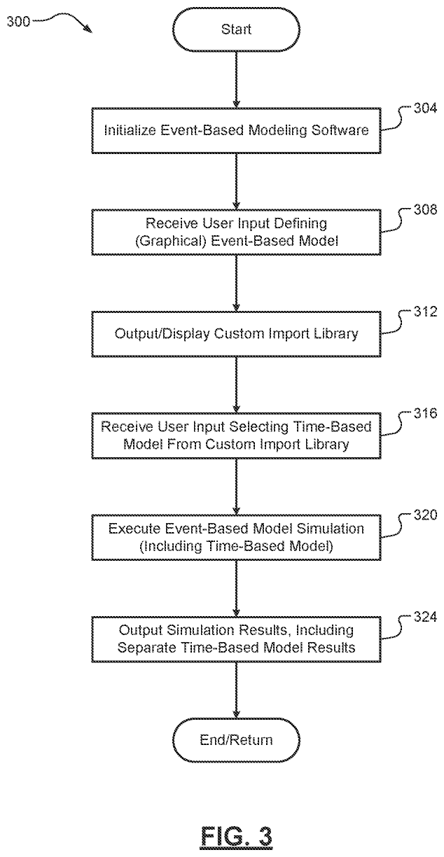

Referring now to FIG. 3, a flow diagram of an example method 300 for enabling time-based modeling via a custom import library in event-based modeling for a vehicle system according to the principles of the present application is illustrated. At 304, the computer system 108 initializes the event-based modeling software tool (e.g., Rhapsody®). At 308, the computer system 108 receives, from a user (e.g., the systems engineer), first input defining an event-based model of the vehicle system 154. At 312, the computer system 108 outputs, to the user, the custom import library 104, 240. At 316, the computer system 108 receives, from the user, second input selecting one of the plurality of time-based models (e.g., dynamic battery model 230, 250). At 320, the computer system 108 executes a simulation of the event-based model, including simulating the selected time-based model. At 324, the computer system 108, upon executing the event-based model, displays, to the user, results of the simulation of the event-based model, including a graphical display of the time-based model simulation (e.g., pop-up window 260). The method 300 then ends or returns to 308 for one or more additional cycles (e.g., further design/simulation).

It will be appreciated that the terms “controller” and “system” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A simulation system for development and verification of a system of a vehicle, the simulation system comprising:
a memory configured to store a custom import library defining a plurality of time-based models for various vehicle systems; and
a computer system configured to access the memory and to:
receive, from a user, first input defining an event-based model of the vehicle system;
during the defining of the event-based model:
output, to the user, the custom import library, and
receive, from the user, second input selecting one of the plurality of time-based models;
execute a simulation of the event-based model, including simulating the selected time-based model; and
upon executing the event-based model, display, to the user, results of the simulation of the event-based model, including a graphical display of the time-based model simulation.

2. The simulation system of claim 1, wherein the event-based model of the vehicle system is a graphical system model.

3. The simulation system of claim 2, wherein the event-based modeling software is IBM Rhapsody® and the time-based modeling software is MathWorks Simulink®.

4. The simulation system of claim 1, wherein the graphical display of the time-based model simulation is a pop-up window within a primary window for defining the event-based model.

5. The simulation system of claim 4, wherein the computer system is further configured to execute a third software that provides the custom import library and the pop-up window via the event-based modeling software.

6. The simulation system of claim 1, wherein the vehicle system is a battery system of the vehicle that is defined by both event-based parameters and time-based parameters.

7. The simulation system of claim 6, wherein the event-based parameters of the battery system include a state of charge (SOC) percentage of the battery system and the time-based parameters of the battery system include at least one of a current, a voltage, and a temperature of the battery system.

8. The simulation system of claim 1, wherein the user is a systems engineer that is not required to interact with a controls engineer.

9. The simulation system of claim 1, wherein the custom import library includes at least one of predefined time-based models for the various vehicle systems and user-defined time-based models for the various vehicle systems.

10. A simulation method for development and verification of a system of a vehicle, the simulation method comprising:
storing, by a memory, a custom import library defining a plurality of time-based models for various vehicle systems;
accessing, by a computer system, the memory;
receiving, by the computer system and from a user, first input defining an event-based model of the vehicle system;
during the defining of the event-based model:
outputting, by the computer system and to the user, the custom import library, and
receiving, by the computer system and from the user, second input selecting one of the plurality of time-based models;
executing, by the computer system, a simulation of the event-based model, including simulating the selected time-based model; and
upon executing the event-based model, displaying, by the computer system and to the user, results of the simulation of the event-based model, including a graphical display of the time-based model simulation.

11. The simulation method of claim 11, wherein the event-based model of the vehicle system is a graphical system model.

12. The simulation method of claim 11, wherein the event-based modeling software is IBM Rhapsody® and the time-based modeling software is MathWorks Simulink®.

13. The simulation method of claim 10, wherein the graphical display of the time-based model simulation is a pop-up window within a primary window for defining the event-based model.

14. The simulation method of claim 13, wherein the computer system is further configured to execute a third software that provides the custom import library and the pop-up window via the event-based modeling software.

15. The simulation method of claim 10, wherein the vehicle system is a battery system of the vehicle that is defined by both event-based parameters and time-based parameters.

16. The simulation method of claim 15, wherein the event-based parameters of the battery system include a state of charge (SOC) percentage of the battery system and the time-based parameters of the battery system include at least one of a current, a voltage, and a temperature of the battery system.

17. The simulation method of claim 10, wherein the user is a systems engineer that is not required to interact with a controls engineer.

18. The simulation method of claim 10, wherein the custom import library includes at least one of predefined time-based models for the various vehicle systems and user-defined time-based models for the various vehicle systems.
